(19) United States
(12) Patent Application Publication
(10) Pub. No.: US 2018/0096168 A1
(43) Pub. Date: Apr. 5, 2018

(54) PassProtect

(71) Applicant: Sabrina Bivins, Fort Walton Beach, FL (US)

(72) Inventor: Sabrina Bivins, Fort Walton Beach, FL (US)

(21) Appl. No.: 15/793,949

(22) Filed: Oct. 25, 2017

Related U.S. Application Data
(60) Provisional application No. 62/412,632, filed on Oct. 25, 2016.

(51) Int. Cl. G06F 21/62; G06F 21/45

(52) U.S. Cl. CPC G06F 21/6245; G06F 21/45

(57) ABSTRACT

This device will:

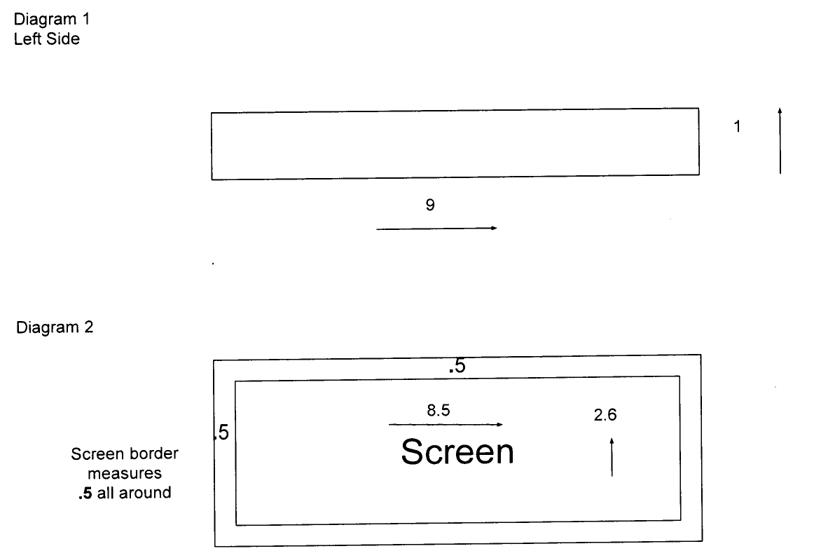

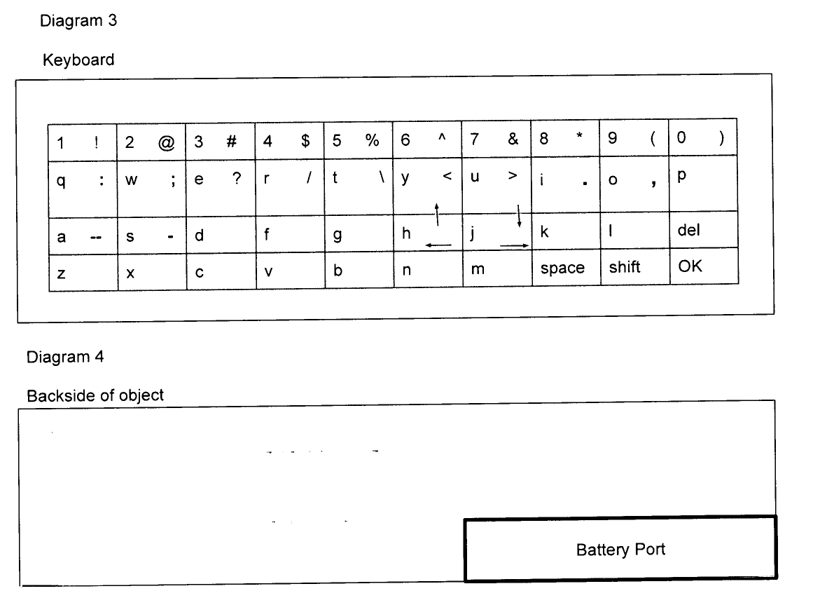

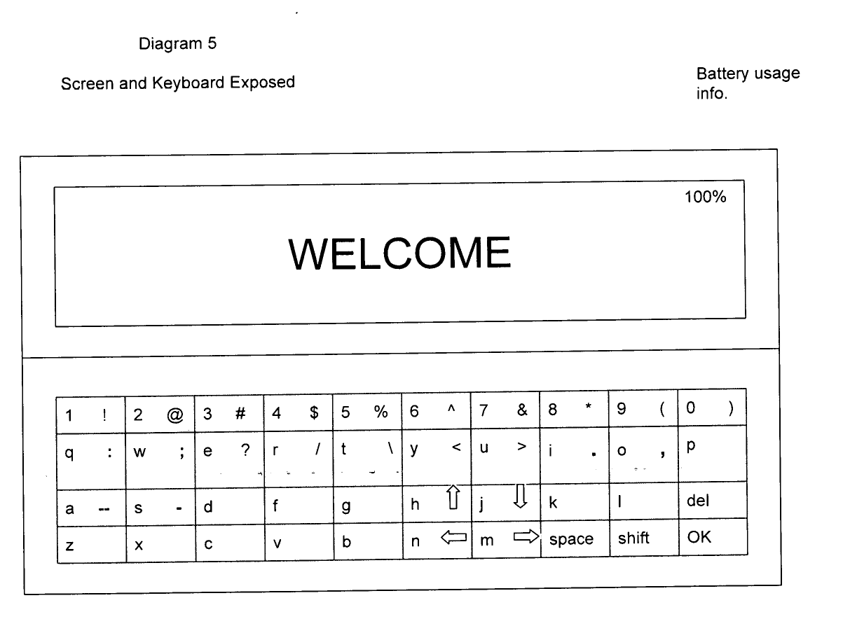

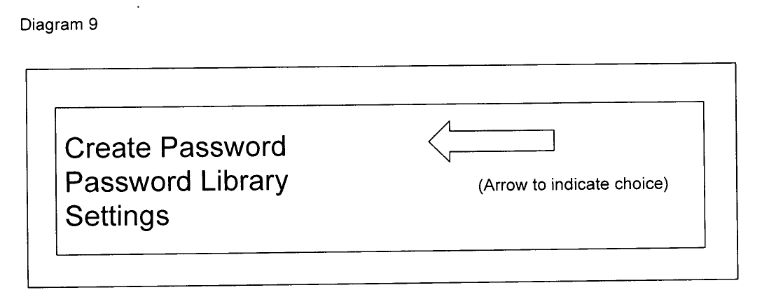

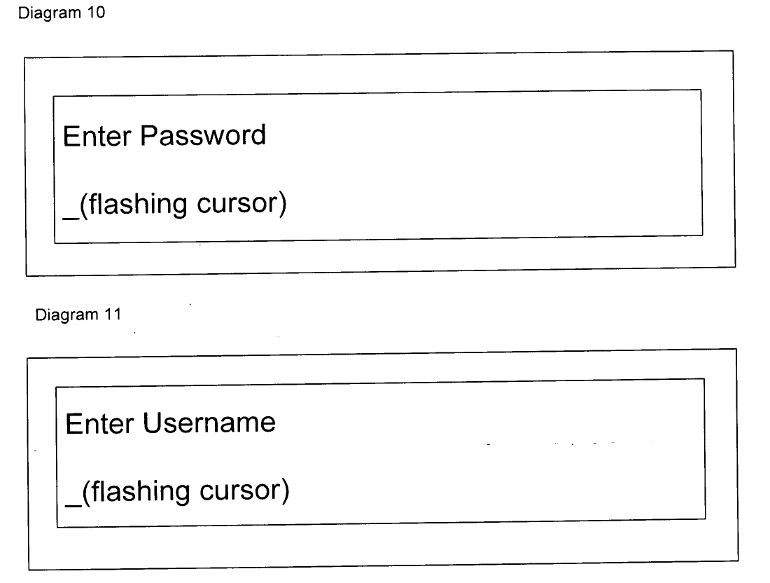

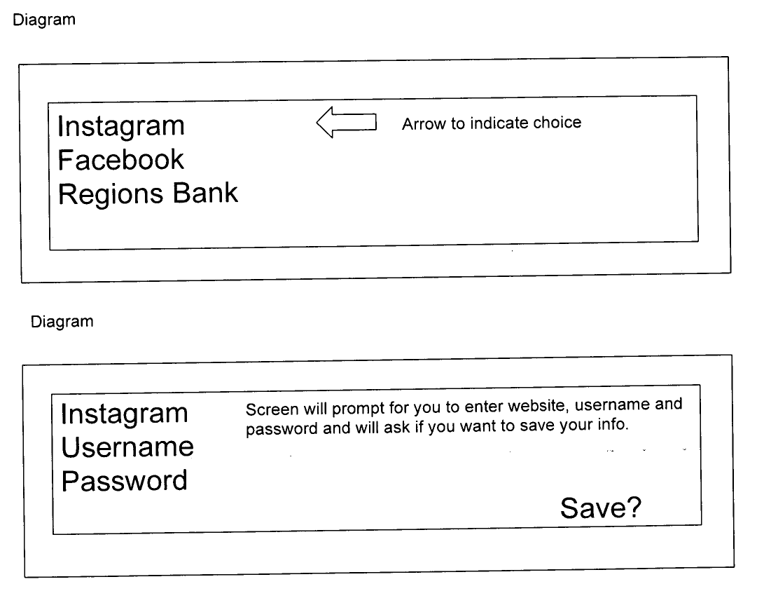

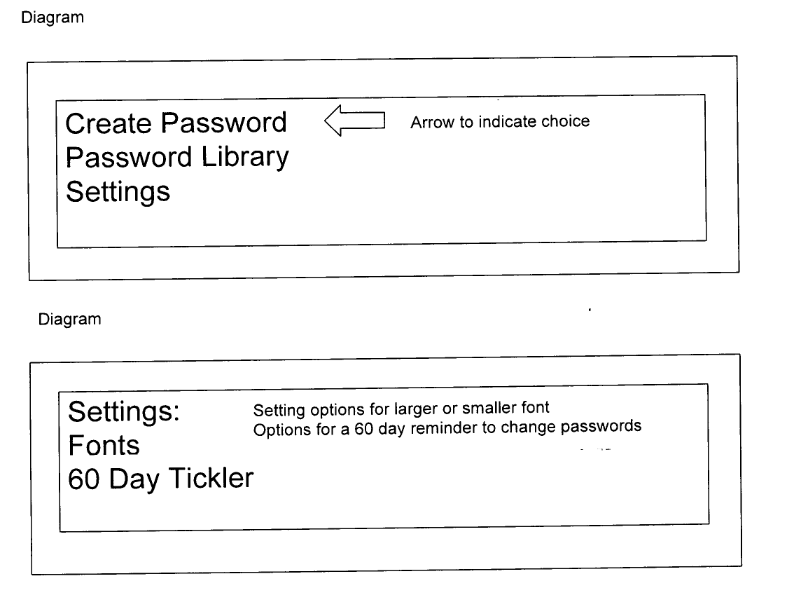

I. It safely stores the following information (website locations, usernames, passwords, bank institutions, routing numbers, account numbers, pin numbers, memos, key phrases, address and contacts) in a place that is not vulnerable to web hacking attacks.

II. That the user the best chance to randomize passwords for maximum protection while using the Internet.

III. It can also include a calendar for entering events.

IV. Optional 6 month alarm to change passwords.

The idea is that all of this information will be stored in a place without internet access, providing a higher level of security for your personal information.

### BACKGROUND

### Field of the Invention

The invention securely keeps passwords, usernames bank information, memos and contacts safe.

### Description of the Related Art

The art is a rough draft. It does however, have a great depiction of accurate size and functions.

### SUMMARY

The device cannot be hacked.

It is has no internet connectivity.

It is battery operated and portable.

Can securely store numerous user names and passwords, bank information, memos and contacts

It provides a way to truly randomize passwords keeping your private information safe

Also features a 6 month reminder/tickler system to change passwords

Settings for large print

### BRIEF DESCRIPTIONS OF THE DRAWINGS

Diagram #1 is the left side of the device showing the measurements and the power button in the upper left corner

Diagram #2 shows the measurements and the screen of the device

Diagram #3 shows the measurements and the keyboard section of the device

Diagram #4 shows the measurements and the back side of the device

Diagram #5 shows the measurements and the right side of the device and the keychain

Diagram #6 is a 3D depiction of the measurements of the device

Diagram #7 shows the measurements and the device extended exposing the screen as well as the keyboard

Diagram #8 shows the welcome and shut down screen

Diagram #9 shows the menu screen

Diagram #10 shows the screen prompting for the website name

Diagram #11 shows the screen prompting for the website name

Diagram #12 shows the screen prompting for the password

Diagram #13 shows the screen for all entries for the selected website

Diagram #14 shows the menu screen for the existing passwords

Diagram #15 shows the settings screen

### DETAILED DESCRIPTION

This device is in the conception stage

The next step would be working out a prototype.

This device is battery operated

Made of hard/durable materials with an exposed screen

The device has a power button on the left side

The device has a keychain on the right hand side

The device slides open vertically exposing the keyboard

The keyboard features the full alphabet as well as numbers and special characters

The keyboard allows for typing

The screen will show tabs

The tabs will read passwords, bank information, contacts and memo

The appropriate tab will open

It will prompt you to enter the appropriate information

The screen will allow you to save the information

The screen will allow you to scroll through to find the information you have saved

The device is meant to be portable/but does not have to be

The device is not meant to have web connectivity/although it can and may at some point

Diagram #1 shows the device in it's resting state from the side view

Diagram #2 shows the device in it's resting state with the screen side up

Diagram #3 shows only the keyboard portion of the device. The keyboard has the full alphabet as well as numbers 1-9 and zero and special characters

Diagram #4 shows the device in it's resting state from the back exposing the batter port

Diagram #5 shows the device in it's resting stated from the right side exposing the keychain

Diagram #6 shows the device in its resting state from a 3D view on the right side

Diagram #7 shows the device. It is in the active state. The vertical “slide up” feature has exposed the keyboard. Now the device is ready to give prompts and record information for later use.

After use the device can be slid down to Diagram #1 and reverted back to it's resting state.

Diagrams 8-15 display prompts of the screen through the process of saving website information to include website name, username and password.

1. This device will truly allow the user to safely store passwords, usernames bank information, memos and contacts safely.
